(19) United States
(12) Patent Application Publication
(10) Pub. No.: US 2023/0065947 A1
(43) Pub. Date: Mar. 2, 2023

(54) MACHINE LEARNING TECHNIQUES FOR COMPOSITE CLASSIFICATION

(71) Applicant: UnitedHealth Group Incorporated, Minnetonka, MN (US)

(72) Inventor: Rachel Mara Gollub, San Jose, CA (US)

(21) Appl. No.: 17/578,028

(22) Filed: Jan. 18, 2022

Related U.S. Application Data
(60) Provisional application No. 63/239,559, filed on Sep. 1, 2021.

(51) Int. Cl. G06K 9/62; G06T 11/20

(52) U.S. Cl. CPC G06K 9/628; G06K 9/6231; G06T 11/206

(57) ABSTRACT

Various embodiments of the present invention provide methods, apparatus, systems, computing devices, computing entities, and/or the like for performing predictive data analysis. Certain embodiments of the present invention utilize systems, methods, and computer program products that perform predictive data analysis operations by utilizing at least one of composite classification scenarios and composite classification scenario scoring machine learning models.

### CROSS-REFERENCES TO RELATED APPLICATION(S)

The present application claims priority to the U.S. Provisional Application No. 63/239,559, filed on Sep. 1, 2021, which is incorporated by reference in its entirety.

### BACKGROUND

Various embodiments of the present invention address technical challenges related to performing predictive data analysis. Various embodiments of the present invention address the shortcomings of existing predictive data analysis systems and disclose various techniques for efficiently and reliably performing predictive data analysis.

### BRIEF SUMMARY

In general, embodiments of the present invention provide methods, apparatus, systems, computing devices, computing entities, and/or the like for performing predictive data analysis. Certain embodiments of the present invention utilize systems, methods, and computer program products that perform predictive data analysis operations by utilizing at least one of composite classification scenarios and composite classification scenario scoring machine learning models.

In accordance with one aspect, a method is provided. In one embodiment, the method comprises: identifying a plurality of classification features, wherein each classification feature is associated with a plurality of classification feature values; identifying a plurality of initial classes, wherein each initial class comprises a per-initial-class input subset of the plurality of classification inputs that are associated with a respective classification feature value for a respective classification feature; determining a plurality of composite classification scenarios, wherein: each composite classification scenario is associated with an n-sized classification feature combination that is selected from the plurality of classification features, each composite classification scenario is associated with n per-scenario initial class subsets of the plurality of initial classes each associated with a corresponding classification feature in the n-sized classification feature combination, and each composite classification scenario is associated with a plurality of per-scenario composite classes each associated with an n-sized per-composite-class initial class subset of the plurality of initial classes comprising n initial classes each being selected from a distinct per-scenario subset for the composite classification scenario; for each composite classification scenario, determining, using a composite classification scenario scoring machine learning model, and based at least in part on each per-scenario composite class for the composite classification scenario, a composite classification scenario score for the composite classification scenario; determining m composite classification scenarios from the plurality of composite classification scenarios based at least in part on each composite classification scenario; and performing one or more classification-based actions based at least in part on the m composite classification scenarios.

In accordance with another aspect, a computer program product is provided. The computer program product may comprise at least one computer-readable storage medium having computer-readable program code portions stored therein, the computer-readable program code portions comprising executable portions configured to: identify a plurality of classification features, wherein each classification feature is associated with a plurality of classification feature values; identify a plurality of initial classes, wherein each initial class comprises a per-initial-class input subset of the plurality of classification inputs that are associated with a respective classification feature value for a respective classification feature; determine a plurality of composite classification scenarios, wherein: each composite classification scenario is associated with an n-sized classification feature combination that is selected from the plurality of classification features, each composite classification scenario is associated with n per-scenario initial class subsets of the plurality of initial classes each associated with a corresponding classification feature in the n-sized classification feature combination, and each composite classification scenario is associated with a plurality of per-scenario composite classes each associated with an n-sized per-composite-class initial class subset of the plurality of initial classes comprising n initial classes each being selected from a distinct per-scenario subset for the composite classification scenario; for each composite classification scenario, determine, using a composite classification scenario scoring machine learning model, and based at least in part on each per-scenario composite class for the composite classification scenario, a composite classification scenario score for the composite classification scenario; determine m composite classification scenarios from the plurality of composite classification scenarios based at least in part on each composite classification scenario; and perform one or more classification-based actions based at least in part on the m composite classification scenarios.

In accordance with yet another aspect, an apparatus comprising at least one processor and at least one memory including computer program code is provided. In one embodiment, the at least one memory and the computer program code may be configured to, with the processor, cause the apparatus to: identify a plurality of classification features, wherein each classification feature is associated with a plurality of classification feature values; identify a plurality of initial classes, wherein each initial class comprises a per-initial-class input subset of the plurality of classification inputs that are associated with a respective classification feature value for a respective classification feature; determine a plurality of composite classification scenarios, wherein: each composite classification scenario is associated with an n-sized classification feature combination that is selected from the plurality of classification features, each composite classification scenario is associated with n per-scenario initial class subsets of the plurality of initial classes each associated with a corresponding classification feature in the n-sized classification feature combination, and each composite classification scenario is associated with a plurality of per-scenario composite classes each associated with an n-sized per-composite-class initial class subset of the plurality of initial classes comprising n initial classes each being selected from a distinct per-scenario subset for the composite classification scenario; for each composite classification scenario, determine, using a composite classification scenario scoring machine learning model, and based at least in part on each per-scenario composite class for the composite classification scenario, a composite classification scenario score for the composite classification scenario; determine m composite classification scenarios from the plurality of composite classification scenarios based at least in part on each composite classification scenario; and perform one or more classification-based actions based at least in part on the m composite classification scenarios.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 is a flowchart diagram of an example process for composite classification of a set of classification inputs in accordance with some embodiments discussed herein.

FIG. 5 is a flowchart diagram of an example process for determining a composite classification scenario score for a particular composite classification scenario in accordance with some embodiments discussed herein.

FIG. 6 is a flowchart diagram of an example process for determining a per-composite-class cost measure for a particular per-scenario composite class in accordance with some embodiments discussed herein.

FIG. 7 is a flowchart diagram of an example process for determining the per-input individual cost measure for a particular classification input in accordance with some embodiments discussed herein.

FIG. 8 provides an operational example of a prediction output user interface in accordance with some embodiments discussed herein.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Advantages

Various embodiments of the present invention address technical challenges related to performing composite classification of a set of classification inputs in a computationally efficient manner. Given n classification features associated with a classification space, there are s=Σᵣ₌₁ⁿn!/r!(n−r)! potential composite classification scenarios (i.e., s ways of arranging r classification features to generate composite classes). In a naïve approach, to determine an optimal composite classification scenarios, O(x*s) operations need to be performed in order to score the s composite classification scenarios, with x being a non-linear factor that may grow based at least in part on interactions across variable-length subsets of composite classes defined by the composite classification scenarios, as well as based at least in part on the computational complexity of cluster evaluation techniques utilized. As a result, existing techniques are computationally inefficient when it comes to detecting composite classification scenarios and performing composite classification of a set of classification inputs in a computationally efficient manner.

To address the challenges associated with performing composite classification of a set of classification inputs in a computationally efficient manner, various embodiments of the present invention distribute the largest per-input individual cost measure for a composite class defined under a composite classification scenario to all of the classification inputs associated with the composite class. The result is a massive simplification of the composite classification scenario optimization process from a computational standpoint, with some embodiments reducing the computational complexity of the overall process to a linear computational complexity that depends on the number of potential composite classification scenarios. Through using the noted techniques, various embodiments of the present invention address technical challenges related to performing composite classification of a set of classification inputs in a computationally efficient manner and make important technical contributions to the field of unsupervised machine learning model.

An operational example of various embodiments of the present invention relates to individual coverage health reimbursement arrangement (ICHRA). ICHRA is a recently approved approach for employers to provide health care for their employees. Rather than choosing group insurance, the employer can divide their employees into a set of groups by a specific combination of legally defined attributes (e.g., zip code, employment status, family configuration, etc.) and choose a single allocation for each group (e.g., either flat or distributed by age). It is advantageous to have a way for employers to easily split the employees into groups (as shown in the below-reproduced screenshot) so that allocations could be calculated easily for each group. However, it may be more advantageous to pre-calculate the most common (and most likely lowest cost) combinations of attributes and present a set of predetermined group divisions for the employer to choose from, leaving manual division of employees as a last option.

Various embodiments of the present invention process a list of employees with all their information, and starting with the most fine-grained division, create cost models for each employee using a method that includes the following operations: pulling the list of available plans for each employee from an individual market database, based at least in part on zip code; using the family structure and age of each family member to calculate total costs for each plan per employee; calculating affordability via a federally approved method determine minimum allocation; establishing the lowest silver, average silver, lowest gold, and average gold plans for each employee; creating a cost model for each reasonable scenario (where likely low cost scenarios are combinations of the classes available, such as age/zip/family/part-time); cloning the above calculated information; dividing the list of employees into the defined classes; finding the maximum allocation necessary to cover the lowest cost silver plan for each member of the class; assigning the detected maximum to each member of the class (moderating by age using the state-mandated age tables if age is one of the chosen classes); summing the total of the assigned allocation of each employee; and comparing the cost models to find the three lowest-cost scenarios, and presenting them to the broker and employer.

### II. Definitions

The term “classification feature” may refer to a data construct that describes a feature whose corresponding feature values are used to divide a set of classification inputs into a set of initial classes. Examples of classification features include features used to define individual coverage health reimbursement arrangement (ICHRA) employee classes, such as a geographical feature, a family tier feature, a member eligibility feature, and/or the like. In some embodiments, an initial class is a subset of the classification inputs that are all associated with a particular classification feature value for a particular classification feature. Accordingly, each initial class is associated with a corresponding classification feature of a corresponding classification feature, where the initial class comprises a per-initial-class input subset of the plurality of classification inputs that are associated with the corresponding classification feature value for the corresponding classification feature.

The term “initial class” may refer to a data construct that describes a subset of classification inputs that are all associated with a classification feature value for a classification feature. Examples of classification features include features used to define ICHRA employee classes, such as a geographical feature, a family tier feature, a member eligibility feature, and/or the like. In some embodiments, an initial class is a subset of the classification inputs that are all associated with a particular classification feature value for a particular classification feature. Accordingly, each initial class is associated with a corresponding classification feature of a corresponding classification feature, where the initial class comprises a per-initial-class input subset of the plurality of classification inputs that are associated with the corresponding classification feature value for the corresponding classification feature. For example, consider a classification feature relating to family tier. This classification feature may in turn be associated with two defined classification feature values: a first classification feature value corresponding to those classification inputs that are associated with employees having children and a second classification feature value corresponding to those classification inputs that are associated with employees not having children. In this example, the family tier classification feature may be used to define two initial classes: a first initial class associated with the first classification feature value as its corresponding classification feature value and the family tier classification feature as its corresponding classification feature, and a second initial class associated with the second classification feature value as its corresponding classification feature value and the family tier classification feature as its corresponding classification feature. Further, in the described example, the per-initial class input subset of the first initial class includes those classification inputs that are associated with employees having children and the per-initial class input subset of the second initial class includes those classification inputs that are associated with employees not having children.

The term “composite classification scenario” may refer to a data construct that describes a set of defined-size composite classes, where the size of a composite class may be the number of initial classes that have been merged to generate the composite class, and where the initial classes used to merge composite classes associated with a particular composite classification scenario are defined by a defined-size combination of classification features associated with the composite classification scenario. An example of a composite classification scenario having a defined size of two may be a composite classification scenario that is associated with a family tier classification feature and a full-time status classification feature. In this example, the combination of the family tier classification feature and the full-time status classification feature may be referred to as the n-sized classification feature combination for the composite classification feature. Furthermore, in the noted example, the composite classification scenario may be associated with two per-scenario initial class subsets: a first per-scenario initial class subset comprising all initial classes generated using the family tier classification feature and a second per-scenario initial class subset comprising all initial classes generated using the full-time status classification feature. Moreover, in the noted example, each composite class associated with the composite classification scenario may be generated by a merger of two initial classes, one selected from the first per-scenario initial class subset and the other selected from the second per-scenario initial class subset.

The term “composite class” may refer to a data construct that describes a subset of classification inputs generated by merging all classification inputs associated with n initial classes, where the n is determined based at least in part on the defined size value associated with the composite classification scenario for the composite class. The n initial classes merged to generate a composite class may include one class from each of n per-scenario initial class subsets, where each per-scenario initial class subset includes all initial classes generated by dividing classification inputs in accordance with the classification feature values of a particular classification feature of n classification features associated with the corresponding composite classification scenario for the composite class. For example, given a composite classification scenario that is associated with a family tier classification feature and a full-time status classification feature, an initial class may generated by merging: (i) an initial class that is selected from an initial class set comprising an initial class corresponding to employees with children and an initial class corresponding to employees without children, and (ii) an initial class that is selected from an initial class set comprising an initial class corresponding to full time employees and an initial class corresponding to part time employees.

The term “composite classification scenario score” may refer to a data construct that describes an overall measure of utility/cost associated with a corresponding composite classification scenario. In some embodiments, determining the composite classification scenario score for a particular composite classification scenario comprises: (i) for each per-scenario composite class associated with the particular composite classification scenario, determining a per-composite-class cost measure based at least in part on each per-input cost measure for a per-composite-class input subset of the plurality of classification inputs that are associated with the n-sized per-composite-class initial class subset for the per-scenario composite class, and (ii) determining, based at least in part on each per-composite-class cost measure, the composite classification scenario score for the particular composite classification scenario. In some embodiments, determining the per-composite-class cost measure for a particular per-scenario composite class that is associated with the particular composite classification scenario comprises: (i) for each classification input in the per-composite-class input subset that is associated with the particular per-scenario composite class, determining a per-input individual cost measure, and (ii) determining a per-composite-class composite cost measure for the particular per-scenario composite class based at least in part on a largest per-input individual cost measure for the per-composite-class input subset that is associated with the particular per-scenario composite class; and (ii) determining the per-composite-class cost measure for the particular per-scenario composite class based at least in part on the per-composite-class composite cost measure.

The term “composite classification scenario scoring machine learning model” may refer to a data construct that describes parameters, hyper-parameters, and/or defined operations of a model that is configured to process feature data associated with a composite classification scenario to generate a composite classification scenario score for the composite classification scenario. Examples of feature data associated with a composite classification scenario include feature data describing per-composite-class cost measures for composite classes defined by the composite classification scenario. In some embodiments, the composite classification scenario machine learning model comprises an aggregation layer that is configured to combine/aggregate (e.g., sum up, average, and/or the like) all per-composite-class cost measures for all composite classes associated with a composite classification scenario (aka. all per-composite-class cost measures for all per-scenario composite classes associated with the composite classification scenario) to generate an aggregation layer output that can then be used to generate the composite classification scenario score for the composite classification scenario. In some embodiments, combining all per-composite-class cost measures for all per-scenario composite classes associated with the composite classification scenario comprises processing all per-composite-class cost measures for all per-scenario composite classes associated with the composite classification scenario using one or more neural network layers (e.g., one or more fully-connected neural network layers) to generate the aggregation layer output. In some embodiments, inputs to the composite classification scenario machine learning model include a vector describing all per-composite-class cost measures for all per-scenario composite classes associated with the composite classification scenario, while outputs of the composite classification scenario machine learning model include a vector or an atomic value describing the composite classification scenario score for the composite classification scenario. In some embodiments, the composite classification scenario machine learning model is trained using training data comprising a set of training data entries, where each training data entry comprises: (i) per-composite-class cost measures for per-scenario composite classes associated with a training composite classification scenario, and (ii) a ground-truth label describing whether a subject matter expert (e.g., a broker) has designated the training composite classification scenario training composite classification scenario as one of the top m composite classification scenarios among a set of composite classification scenarios.

The term “per-composite-class cost measure” may refer to a data construct that describes a measure of cost/utility associated with a composite class. In some embodiments, determining the per-composite-class cost measure for a particular per-scenario composite class that is associated with the particular composite classification scenario comprises: (i) for each classification input in the per-composite-class input subset that is associated with the particular per-scenario composite class, determining a per-input individual cost measure, and (ii) determining a per-composite-class composite cost measure for the particular per-scenario composite class based at least in part on a largest per-input individual cost measure for the per-composite-class input subset that is associated with the particular per-scenario composite class; and (ii) determining the per-composite-class cost measure for the particular per-scenario composite class based at least in part on the per-composite-class composite cost measure.

The term “per-input individual cost measure” may refer to a data construct that describes a measure of cost/utility associated with a classification input. For example, in some embodiments, the per-input individual cost measure for a particular classification input that is associated with a particular employee may describe an estimated/computed measure of employer contribution for a target cost category (e.g., a target health insurance plan type, such as a cheapest health insurance plan type) for the per-input individual cost measure. In some of the noted embodiments, the per-input individual cost measure for a particular classification input that is associated with a particular employee may describe an age-adjusted estimated/computed measure of employer contribution for a target cost category (e.g., a target health insurance plan type, such as a cheapest health insurance plan type) for the per-input individual cost measure, where the age-adjusted estimated/computed measure of employer contribution is determined by assuming that the employer has a baseline age (e.g., a baseline age of twenty years old).

The term “per-input initial cost measure” may refer to a data construct that describes a cost/utility measure for a classification input that is determined before any adjustments made in accordance with an adjustment feature. An example of a per-input initial cost measure may be a measure of employer contribution for a corresponding employee for a target health insurance plan that is determined based at least in part on a total cost of the target health insurance plan for the employee and a defined employer share of the total cost, without adjusting for employee. In some embodiments, the per-input initial cost measure for a particular classification input is determined using a cost determination machine learning model associated with a target cost category.

The term “cost determination machine learning model” may refer to a data construct that describes parameters, hyper-parameters, and/or defined operations of a model that is configured to process input feature data (e.g., demographic data, health history data, and/or the like) for a classification input to generate a predictive output (e.g., a total cost/utility measure) for the classification input with respect to a target cost category, where the predictive output can be used (e.g., in combination with a cost distribution ratio such as an employer contribution ratio) to generate the per-input initial cost measure for the particular classification input. In some embodiments, the cost determination machine learning model comprises one or more neural network layers, such as one or more fully-connected neural network layers. In some embodiments, input feature data processed by the cost determination machine learning model with respect to a classification input include an adjustment feature value (e.g., an age value) for the classification input, as further described below. Accordingly, in some embodiments, the predictive output generated by the cost determination machine learning model is a cost/utility measure for a classification input that is determined without discounting/adjusting for the features associated with an adjustment feature such as age. In some embodiments, inputs to the cost determination machine learning model comprise a vector describing input feature data for a classification input, while outputs of the cost determination machine learning model include a vector and/or an atomic value describing the predictive output corresponding to the classification input. In some embodiments, the cost determination machine learning model can be trained using training data describing historical costs associated with particular plans/service items for particular classification inputs.

The term “per-input adjustment factor” may refer to a data construct that describes a measure of contribution of an adjustment feature value for a particular classification input to the per-input initial cost measure for the particular classification input. For example, the per-input adjustment factor for a particular classification input may describe a ratio of: (i) the per-input initial cost measure for the particular classification input, and (ii) a baseline per-input initial cost measure for a classification input that is associated with all of the input feature data for the particular classification input except for a baseline adjustment feature value (e.g., a baseline age value, such as a baseline age value of 20 years old). In some embodiments, to generate the per-input adjustment factor for a particular classification input, the following operations are performed: (i) processing input feature data associated with the particular classification input using the cost determination machine learning model to generate a predictive output that can then be used to generate a per-input initial cost measure for the particular classification input, (ii) determining a baseline classification input that is associated with all of the input feature data of the particular classification input except that the adjustment feature value of the classification input is replaced by a baseline adjustment feature value, (iii) processing input feature data associated with the baseline classification input using the cost determination machine learning model to generate a predictive output that can then be used to generate a baseline per-input initial cost measure for the baseline classification input, and (iv) determining the per-input adjustment factor based at least in part on a ratio of the per-input initial cost measure and the baseline per-input initial cost measure. For example, consider an employee that is 40 years old and is associated with an employer contribution measure of $1200 for a target health insurance plan. If using a cost determination machine learning model, a proposed system determines that the same employee would have had incurred an employer contribution measure of $1000 if the employee had a baseline age of 20 years old, then the adjustment factor for the employee may be determined based at least in part on the output of $1,200/$1,000=1.2.

The term “adjustment feature value” may refer to a data construct that describes a feature value of a classification input that can be used to determine the per-input adjustment factor for the classification input. In some embodiments, the per-input adjustment factor for a particular classification input is determined based at least in part on an adjustment feature (e.g., an age feature) having an adjustment feature range (e.g., an age value range of 20 to 80 years old, an age value range of 20 years and higher, and/or the like), each classification input is associated with an adjustment feature value (e.g., an age value) for the adjustment factor, and the adjustment factor for classification inputs having a smallest adjustment feature value (e.g., a baseline age value, such as a baseline age value of 20 years old) in the adjustment feature range are associated with an initial adjustment factor. Thus, in some embodiments, the baseline adjustment feature value for an adjustment feature is the smallest adjustment feature value for an adjustment feature range of the adjustment feature value.

The term “per-composite-class composite cost measure” may refer to a data construct that describes a measure of statistical distribution of per-input individual cost measures for classification inputs that are associated with a corresponding composite class. In some embodiments, given a composite class including x classification inputs which are associated with x corresponding per-input individual cost measures, the largest of the x corresponding per-input individual cost measures is adopted as the per-composite-class composite cost measure for the particular composite class. For example, given a set of x employees in a particular composite class that are associated with x corresponding age-adjusted employer contribution measures, the largest age-adjusted employer contribution measure of the x corresponding age-adjusted employer contribution measures is adopted as the per-composite-class composite cost measure for the composite class. In some embodiments, given a composite class including x classification inputs which are associated with x corresponding per-input individual cost measures, an average measure of the largesty per-input individual cost measures of the x corresponding per-input individual cost measures is adopted as the per-composite-class composite cost measure for the particular composite class. For example, given a set of x employees in a particular composite class that are associated with x corresponding age-adjusted employer contribution measures, an average measure of the largesty age-adjusted employer contribution measures of the x corresponding age-adjusted employer contribution measures is adopted as the per-composite-class composite cost measure for the composite class.

The term “classification feature combination” may refer to a data construct that describes a defined-size set of classification features that are associated with a composite classification scenario. For example, consider an exemplary embodiment in which the set of classification features include a family tier classification feature, a full-time status classification feature, and a salaried status classification feature, where the family tier classification feature is associated with a first classification feature value describing whether an employee is married with children and a second classification feature value describing whether an employee is not married with children, the full-time status classification feature is associated with a third classification feature value describing whether an employee is full time and a fourth classification feature value describing whether an employee is part time, and the salaried status classification feature is associated with a fifth classification feature value describing whether an employee is salaried and a sixth classification feature value describing whether an employee is non-salaried. In this example, if the value of n ranges from 1 to 3, then for n=3, a composite classification scenario whose n-sized classification feature combination includes the family tier classification status, the full-time status classification feature, and the salaried status classification feature can be generated.

The term “per-scenario initial class subset” may refer to a data construct that describes a set of all initial classes that are associated with a particular classification feature of a particular composite classification scenario. For example, consider an exemplary embodiment in which the set of classification features include a family tier classification feature, a full-time status classification feature, and a salaried status classification feature, where the family tier classification feature is associated with a first classification feature value describing whether an employee is married with children and a second classification feature value describing whether an employee is not married with children, the full-time status classification feature is associated with a third classification feature value describing whether an employee is full time and a fourth classification feature value describing whether an employee is part time, and the salaried status classification feature is associated with a fifth classification feature value describing whether an employee is salaried and a sixth classification feature value describing whether an employee is non-salaried. In this example, the per-scenario initial class subsets for a composite classification scenario that is associated with all three of the noted classification features include: (i) a first per-scenario initial class subset associated with the family tier classification feature that includes, (ii) a second per-scenario initial class subset associated with the full-time status classification feature that includes a third initial class corresponding to the third classification feature value and a fourth initial class corresponding to the fourth classification feature value, and (iii) a third per-scenario initial class subset associated with the salaried status classification feature that includes a fifth initial class corresponding to the fifth classification feature value and a sixth initial class corresponding to the sixth classification feature value.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

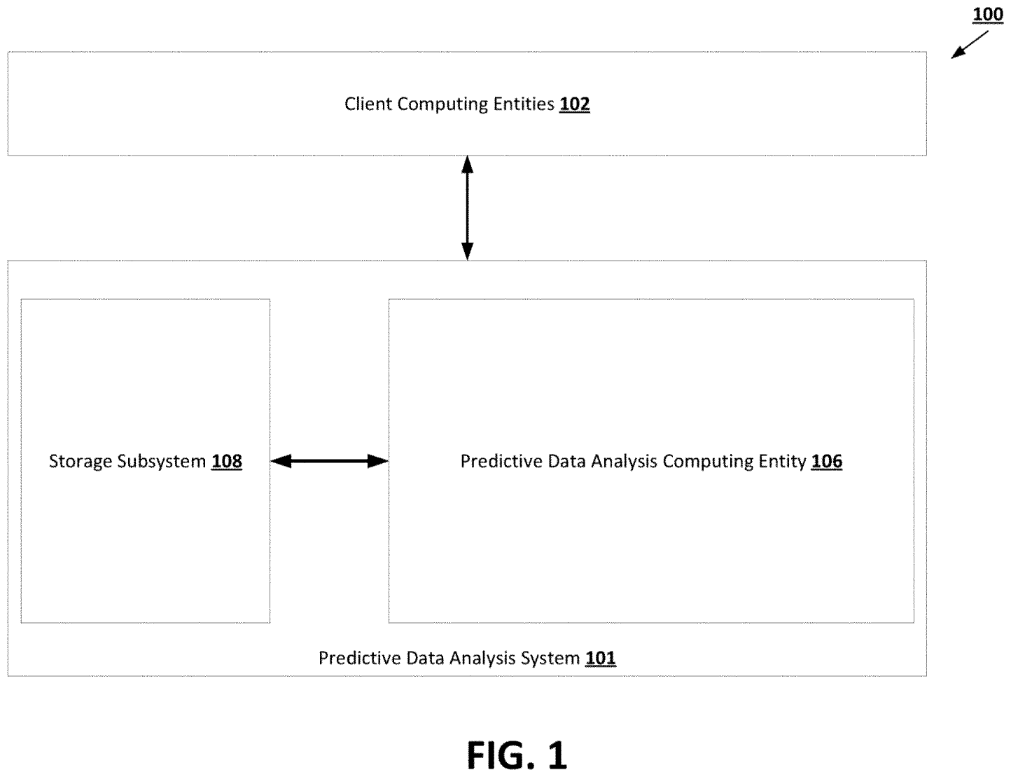

FIG. 1 is a schematic diagram of an example architecture 100 for performing health-related predictive data analysis. The architecture 100 includes a predictive data analysis system 101 configured to receive health-related predictive data analysis requests from external computing entities 102, process the predictive data analysis requests to generate predictions, provide the generated predictions to the external computing entities 102, and automatically perform classification-based actions based at least in part on the predictions. Examples of classification-based actions include generating and/or displaying ICHRA plan scenarios for an ICHRA proposal.

In some embodiments, predictive data analysis system 101 may communicate with at least one of the external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more external computing entities 102, process the predictive data analysis requests to generate predictions corresponding to the predictive data analysis requests, provide the predictions to the external computing entities 102, and automatically perform classification-based actions based at least in part on the generated predictions.

The storage subsystem 108 may be configured to store input data used by the predictive data analysis computing entity 106 to perform health-related predictive data analysis as well as model definition data used by the predictive data analysis computing entity 106 to perform various health-related predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

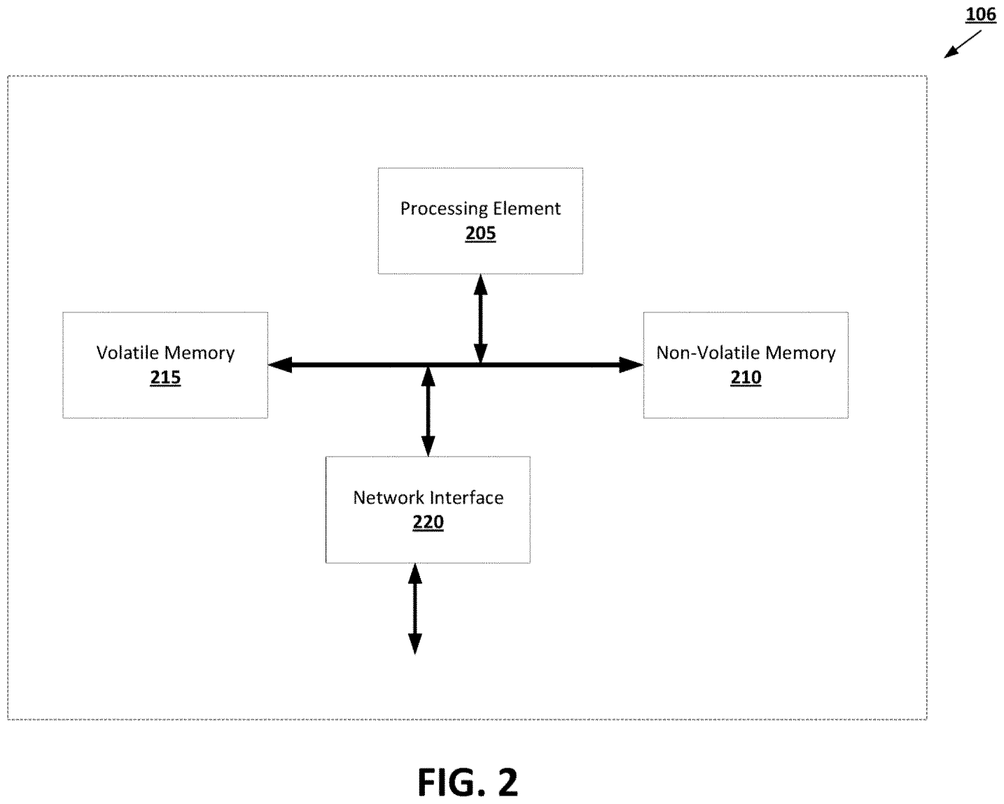

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include or be in communication with one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include or be in communication with one or more input elements, such as a keyboard input, a mouse input, a touch screen/display input, motion input, movement input, audio input, pointing device input, joystick input, keypad input, and/or the like. The predictive data analysis computing entity 106 may also include or be in communication with one or more output elements (not shown), such as audio output, video output, screen/display output, motion output, movement output, and/or the like.

### Exemplary External Computing Entity

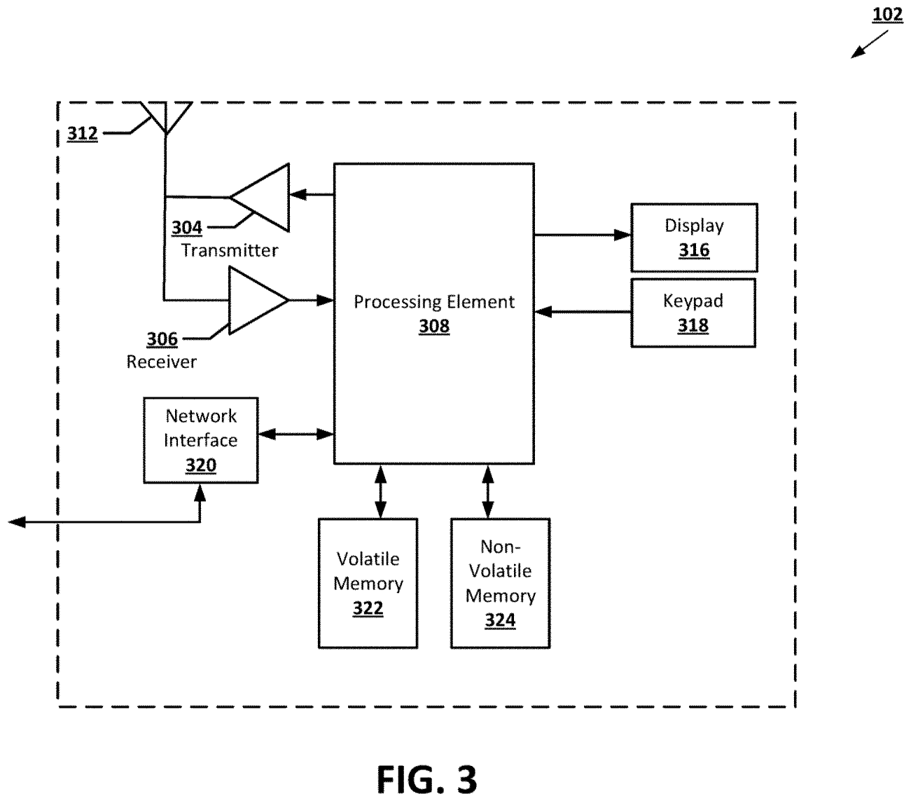

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

As discussed below, to address the challenges associated with performing composite classification of a set of classification inputs in a computationally efficient manner, various embodiments of the present invention distribute the largest per-input individual cost measure for a composite class defined under a composite classification scenario to all of the classification inputs associated with the composite class. The result is a massive simplification of the composite classification scenario optimization process from a computational standpoint, with some embodiments reducing the computational complexity of the overall process to a linear computational complexity that depends on the number of potential composite classification scenarios. Through using the noted techniques, various embodiments of the present invention address technical challenges related to performing composite classification of a set of classification inputs in a computationally efficient manner and make important technical contributions to the field of unsupervised machine learning model.

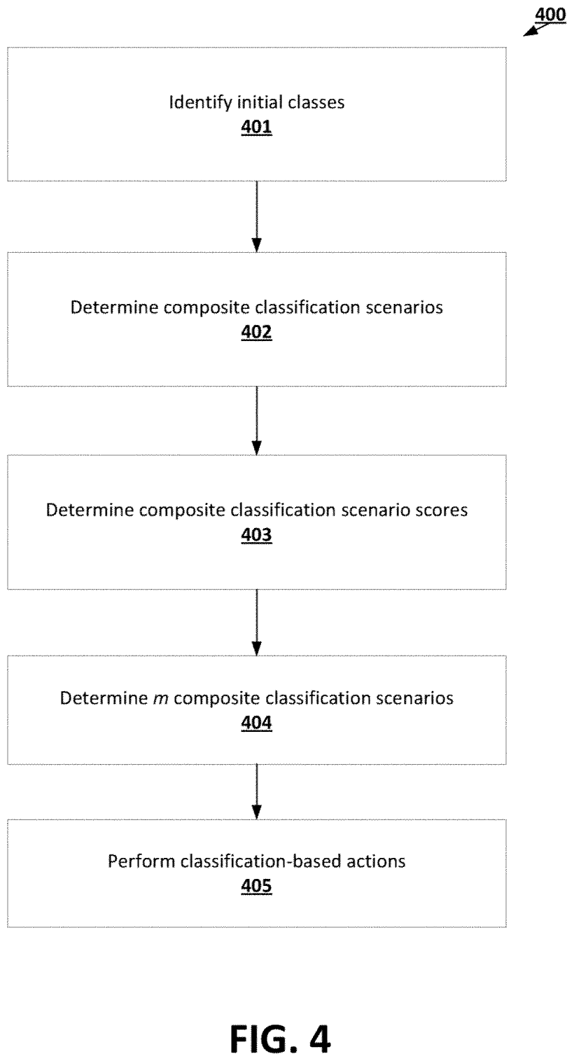

FIG. 4 is a flowchart diagram of an example process for composite classification of a set of classification inputs. Via the various steps/operations of the process 400, the predictive data analysis computing entity 106 can use a set of initial classes to generate composite classes by merging initial classes in a computationally efficient manner that avoids the need for complex non-linear adjustments of cost/utility measures.

The process 400 begins at step/operation 401 when the predictive data analysis computing entity 106 identifies (e.g., generates/determines, receives, and/or the like) a set of initial classes, where each initial class includes a subset of the classification inputs. An example of an initial class is an individual coverage health reimbursement arrangement (ICHRA) class of employees.

In some embodiments, inputs to process 400 include: (i) the set of classification inputs (e.g., each describing target feature data associated with an employee of an organization), and (ii) a set of classification features. Examples of classification features include features used to define ICHRA employee classes, such as a geographical feature, a family tier feature, a member eligibility feature, and/or the like. In some embodiments, an initial class is a subset of the classification inputs that are all associated with a particular classification feature value for a particular classification feature. Accordingly, each initial class is associated with a corresponding classification feature of a corresponding classification feature, where the initial class comprises a per-initial-class input subset of the plurality of classification inputs that are associated with the corresponding classification feature value for the corresponding classification feature.

For example, consider a family tier classification feature relating to family tier of employees. This classification feature may in turn be associated with two defined classification feature values: a first classification feature value corresponding to those classification inputs that are associated with employees having children and a second classification feature value corresponding to those classification inputs that are associated with employees not having children. In this example, the family tier classification feature may be used to define two initial classes: a first initial class associated with the first classification feature value as its corresponding classification feature value and the family tier classification feature as its corresponding classification feature, and a second initial class associated with the second classification feature value as its corresponding classification feature value and the family tier classification feature as its corresponding classification feature. Further, in the described example, the per-initial class input subset of the first initial class includes those classification inputs that are associated with employees having children and the per-initial class input subset of the second initial class includes those classification inputs that are associated with employees not having children.

Accordingly, in some embodiments, givenf classification features each having v classification feature values, f*v initial classes may be generated. Of course, a person of ordinary skill in the relevant technology will recognize that different classification features may have different counts of defined classification feature values. For example, given three classification features where the first classification feature has ci classification feature values, the second classification feature has c2 classification feature values, and the third classification feature has c₃ classification feature values, c₁+c₂+c₃ initial classes may be generated.

At step/operation 402, the predictive data analysis computing entity 106 determines a set of composite classification scenarios. In some embodiments, each composite classification scenario is associated with an n-sized classification feature combination that is selected from the plurality of classification features, each composite classification scenario is associated with n per-scenario initial class subsets of the plurality of initial classes each associated with a corresponding classification feature in the n-sized classification feature combination, and each composite classification scenario is associated with a plurality of per-scenario composite classes each associated with an n-sized per-composite-class initial class subset of the plurality of initial classes comprising n initial classes each being selected from a distinct per-scenario subset for the composite classification scenario.

An example of a composite classification scenario includes a composite classification scenario associated with a set of composite classes that are formed by merging initial classes based at least in part on a unique combination of ICHRA classification features. For example, consider an exemplary embodiment in which the set of classification features include a family tier classification feature, a full-time status classification feature, and a salaried status classification feature, where the family tier classification feature is associated with a first classification feature value describing whether an employee is married with children and a second classification feature value describing whether an employee is not married with children, the full-time status classification feature is associated with a third classification feature value describing whether an employee is full time and a fourth classification feature value describing whether an employee is part time, and the salaried status classification feature is associated with a fifth classification feature value describing whether an employee is salaried and a sixth classification feature value describing whether an employee is non-salaried. In this example, if the value of n ranges from 1 to 3, then the following composite classification scenarios may be generated:

(1) A first composite classification scenario associated with n=1 whose n-sized classification feature combination includes the family tier classification feature, where the n per-scenario initial class subsets for the first composite classification scenario include a per-scenario initial class subset that is associated with a first initial class corresponding to the first classification feature value and a second initial class corresponding to the second classification feature value, and where the composite classes associated with the first composite classification scenario include a first composite class that comprises classification inputs associated with the first initial class and a second composite class that comprises classification inputs associated with the second initial class;

(2) A second composite classification scenario associated with n=1 whose n-sized classification feature combination includes the full-time status classification feature, where the n per-scenario initial class subsets for the second composite classification scenario include a per-scenario initial class subset that is associated with a third initial class corresponding to the third classification feature value and a fourth initial class corresponding to the fourth classification feature value, and where the composite classes associated with the second composite classification scenario include a third composite class that comprises classification inputs associated with the third initial class and a fourth composite class that comprises classification inputs associated with the fourth initial class;

(3) A third composite classification scenario associated with n=1 whose n-sized classification feature combination includes the salaried status classification feature, where the n per-scenario initial class subsets for the third composite classification scenario include a per-scenario initial class subset that is associated with a fifth initial class corresponding to the fifth classification feature value and a sixth initial class corresponding to the sixth classification feature value, and where the composite classes associated with the third composite classification scenario include a fifth composite class that comprises classification inputs associated with the fifth initial class and a sixth composite class that comprises classification inputs associated with the sixth initial class;

(4) A fourth composite classification scenario associated with n=2 whose n-sized classification feature combination includes the family tier classification feature and the full-time status classification feature, where the n per-scenario initial class subsets for the fourth composite classification scenario include a per-scenario initial class subset that is associated with the first initial class and the second initial class and a per-scenario initial class subset that is associated with the third initial class and the fourth initial class, and where the composite classes associated with the fourth composite classification scenario include: (i) a seventh composite class associated with a merger of the first initial class and the third initial class, (ii) an eighth composite class associated with a merger of the first initial class and the fourth initial class, (iii) a ninth composite class associated with a merger of the second initial class and the third initial class, and (iv) a tenth composite class associated with a merger of the second initial class and the fourth initial class;

(5) A fifth composite classification scenario associated with n=2 whose n-sized classification feature combination includes the family tier classification feature and the salaried status classification feature, where the n per-scenario initial class subsets for the fifth composite classification scenario include a per-scenario initial class subset that is associated with the first initial class and the second initial class and a per-scenario initial class subset that is associated with the fifth initial class and the sixth initial class, and where the composite classes associated with the fifth composite classification scenario include: (i) an eleventh composite class associated with a merger of the first initial class and the fifth initial class, (ii) a twelfth composite class associated with a merger of the first initial class and the sixth initial class, (iii) a thirteenth composite class associated with a merger of the second initial class and the fifth initial class, and (iv) a fourteenth composite class associated with a merger of the second initial class and the sixth initial class;

(6) A sixth composite classification scenario associated with n=2 whose n-sized classification feature combination includes the full-time status classification feature and the salaried status classification feature, where the n per-scenario initial class subsets for the sixth composite classification scenario include a per-scenario initial class subset that is associated with the third initial class and the fourth initial class and a per-scenario initial class subset that is associated with the fifth initial class and the sixth initial class, and where the composite classes associated with the sixth composite classification scenario include: (i) a fifteenth composite class associated with a merger of the third initial class and the fifth initial class, (ii) a sixteenth composite class associated with a merger of the third initial class and the sixth initial class, (iii) a seventeenth composite class associated with a merger of the fourth initial class and the fifth initial class, and (iv) an eighteenth composite class associated with a merger of the fourth initial class and the sixth initial class; and

(7) A seventh composite classification scenario associated with n=3 whose n-sized classification feature combination includes the family tier classification status, the full-time status classification feature, and the salaried status classification feature, where the n per-scenario initial class subsets for the seventh composite classification scenario include: (i) a per-scenario initial class subset that is associated with the first initial class and the second initial class, (ii) a per-scenario initial class subset that is associated with the third initial class and the fourth initial class, and (iii) a per-scenario initial class subset that is associated with the fifth initial class and the sixth initial class, and where the composite classes associated with the seventh composite classification scenario include: (i) a nineteenth composite class associated with a merger of the first initial class, the third initial class, and the fifth initial class, (ii) a twentieth composite class associated with a merger of the first initial class, the third initial class, and the sixth initial class, (iii) a twenty-first composite class associated with a merger of the first initial class, the fourth initial class, and the fifth initial class, (iv) a twenty-second composite class associated with a merger of the first initial class, the fourth initial class, and the sixth initial class, (v) a twenty-third composite class associated with a merger of the second initial class, the third initial class, and the fifth initial class, (vi) a twenty-fourth composite class associated with a merger of the second initial class, the third initial class, and the sixth initial class, (vii) a twenty-fifth composite class associated with a merger of the second initial class, the fourth initial class, and the fifth initial class, and (viii) a twenty-sixth composite class associated with a merger of the second initial class, the fourth initial class, and the sixth initial class.

Accordingly, n may be a value that ranges over a defined discrete range, such that, for example, given three classification features and an n that ranges over 1 to 3, seven composite classification scenarios associated collectively with twenty six composite classes may be generated. A composite classification scenario may thus in some embodiments describe a set of defined-size composite classes, where the size of a composite class may be the number of initial classes that have been merged to generate the composite class, and where the initial classes used to merge composite classes associated with a particular composite classification scenario are defined by a defined-size combination of classification features associated with the composite classification scenario. An example of a composite classification scenario having a defined size of two may be a composite classification scenario that is associated with a family tier classification feature and a full-time status classification feature. In this example, the combination of the family tier classification feature and the full-time status classification feature may be referred to as the n-sized classification feature combination for the composite classification feature. Furthermore, in the noted example, the composite classification scenario may be associated with two per-scenario initial class subsets: a first per-scenario initial class subset comprising all initial classes generated using the family tier classification feature and a second per-scenario initial class subset comprising all initial classes generated using the full-time status classification feature. Moreover, in the noted example, each composite class associated with the composite classification scenario may be generated by a merger of two initial classes, one selected from the first per-scenario initial class subset and the other selected from the second per-scenario initial class subset.

Accordingly, a composite class is a subset of classification inputs generated by merging all classification inputs associated with n initial classes, where the n is determined based at least in part on the defined size value associated with the composite classification scenario for the composite class. The n initial classes merged to generate a composite class may include one class from each of n per-scenario initial class subsets, where each per-scenario initial class subset includes all initial classes generated by dividing classification inputs in accordance with the classification feature values of a particular classification feature of n classification features associated with the corresponding composite classification scenario for the composite class. For example, given a composite classification scenario that is associated with a family tier classification feature and a full-time status classification feature, an initial class may generated by merging: (i) an initial class that is selected from an initial class set comprising an initial class corresponding to employees with children and an initial class corresponding to employees without children, and (ii) an initial class that is selected from an initial class set comprising an initial class corresponding to full time employees and an initial class corresponding to part time employees. As described above, during the same iteration of the process 400, different composite classification scenario may be associated with an n (i.e., size) value that is different from the n values associated with other composite classification scenarios.

At step/operation 403, the predictive data analysis computing entity 106 determines a composite classification scenario score for each composite classification scenario using a composite classification scenario machine learning model. A composite classification scenario score may describe an overall measure of utility/cost associated with a corresponding composite classification scenario. In some embodiments, determining the composite classification scenario score for a particular composite classification scenario comprises: (i) for each per-scenario composite class associated with the particular composite classification scenario, determining a per-composite-class cost measure based at least in part on each per-input cost measure for a per-composite-class input subset of the plurality of classification inputs that are associated with the n-sized per-composite-class initial class subset for the per-scenario composite class, and (ii) determining, based at least in part on each per-composite-class cost measure, the composite classification scenario score for the particular composite classification scenario. In some embodiments, determining the per-composite-class cost measure for a particular per-scenario composite class that is associated with the particular composite classification scenario comprises: (i) for each classification input in the per-composite-class input subset that is associated with the particular per-scenario composite class, determining a per-input individual cost measure, and (ii) determining a per-composite-class composite cost measure for the particular per-scenario composite class based at least in part on a largest per-input individual cost measure for the per-composite-class input subset that is associated with the particular per-scenario composite class; and (ii) determining the per-composite-class cost measure for the particular per-scenario composite class based at least in part on the per-composite-class composite cost measure.

By using per-composite-class composite cost measures in the manner described above, various embodiments of the present invention distribute the largest per-input individual cost measure for a composite class defined under a composite classification scenario to all of the classification inputs associated with the composite class. The result is a massive simplification of the composite classification scenario optimization process from a computational standpoint, with some embodiments reducing the computational complexity of the overall process to a linear computational complexity that depends on the number of potential composite classification scenarios. Through using the noted techniques, various embodiments of the present invention address technical challenges related to performing composite classification of a set of classification inputs in a computationally efficient manner and make important technical contributions to the field of unsupervised machine learning model.

In some embodiments, the composite classification scenario machine learning model is configured to process feature data associated with a composite classification scenario to generate a composite classification scenario score for the composite classification scenario. Examples of feature data associated with a composite classification scenario include feature data describing per-composite-class cost measures for composite classes defined by the composite classification scenario. In some embodiments, the composite classification scenario machine learning model comprises an aggregation layer that is configured to combine/aggregate (e.g., sum up, average, and/or the like) all per-composite-class cost measures for all composite classes associated with a composite classification scenario (aka. all per-composite-class cost measures for all per-scenario composite classes associated with the composite classification scenario) to generate an aggregation layer output that can then be used to generate the composite classification scenario score for the composite classification scenario. In some embodiments, combining all per-composite-class cost measures for all per-scenario composite classes associated with the composite classification scenario comprises processing all per-composite-class cost measures for all per-scenario composite classes associated with the composite classification scenario using one or more neural network layers (e.g., one or more fully-connected neural network layers) to generate the aggregation layer output. In some embodiments, inputs to the composite classification scenario machine learning model include a vector describing all per-composite-class cost measures for all per-scenario composite classes associated with the composite classification scenario, while outputs of the composite classification scenario machine learning model include a vector or an atomic value describing the composite classification scenario score for the composite classification scenario.

In some embodiments, the composite classification scenario machine learning model is trained using training data comprising a set of training data entries, where each training data entry comprises: (i) per-composite-class cost measures for per-scenario composite classes associated with a training composite classification scenario, and (ii) a ground-truth label describing whether a subject matter expert (e.g., a broker) has designated the training composite classification scenario training composite classification scenario as one of the top m composite classification scenarios among a set of composite classification scenarios. In some embodiments, the composite classification scenario machine learning model is trained using training data comprising a set of training data entries, where each training data entry comprises: (i) per-composite-class cost measures for per-scenario composite classes associated with a training composite classification scenario, and (ii) a ground-truth value describing whether a subject matter expert (e.g., a broker) has designated the training composite classification scenario training composite classification scenario as one of the top m composite classification scenarios among a set of composite classification scenarios and (if so) which position of the m composite classification scenarios has been assigned to the training composite classification scenario by the subject matter expert.

For example, in some embodiments, the ground-truth label of a training composite classification scenario may be 1 if the training composite classification scenario has been deemed to be one of the top m composite classification scenarios among a set of composite classification scenarios by a subject matter expert, and may be 0 otherwise. In some of the noted embodiments, the composite classification scenario machine learning model is configured to, during a training iteration for a corresponding training data entry, process per-composite-class cost measures for per-scenario composite classes associated with the training composite classification scenario to generate an output value between [0, 1]. The training composite classification scenario may then be trained to optimize an error function determined based at least in part on a measure of deviation between the output value and the ground-truth label.

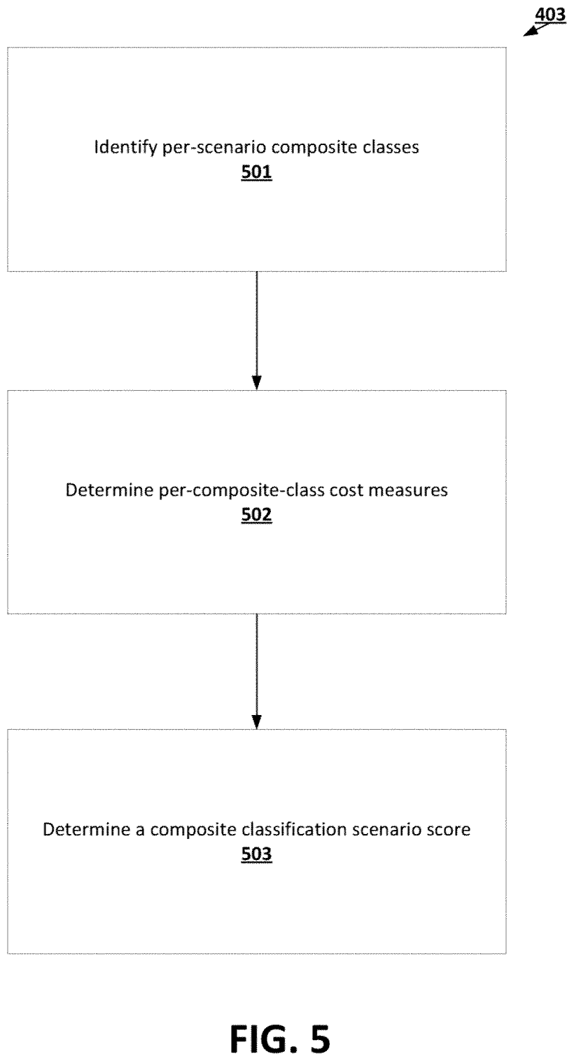

In some embodiments, step/operation 403 may be performed in accordance with the process that is depicted in FIG. 5, which is an example process for determining a composite classification scenario score for a particular composite classification scenario. The process that is depicted in FIG. 5 begins at step/operation 501 when the predictive data analysis computing entity 106 identifies per-scenario composite classes associated with the particular composite classification scenario. As described above, given a composite classification scenario that is associated with a particular n value and a particular subset of n classification features, the per-scenario composite classes for the composite classification scenario include each composite class that is generated by merging n initial classes, where each merged initial class is selected from the initial classes generated using classification feature values for one of the n classification features. In some embodiments, given a composite classification scenario that is associated with n classification features, the number of per-scenario composite classes associated with the composite classification scenario can be determined using the equation z₁*z₂* . . . *zₙ, where each zᵢ value describes a count of initial classes generated using classification feature values associated with an ith classification features of the n classification features associated with the composite classification scenario.

At step/operation 502, the predictive data analysis computing entity 106 determines a per-composite-class cost measure for each per-scenario composite class that is associated with the particular composite classification scenario. In some embodiments, the per-composite-class cost measure for a composite class is a measure of cost/utility associated with a composite class. In some embodiments, determining the per-composite-class cost measure for a particular per-scenario composite class that is associated with the particular composite classification scenario comprises: (i) for each classification input in the per-composite-class input subset that is associated with the particular per-scenario composite class, determining a per-input individual cost measure, and (ii) determining a per-composite-class composite cost measure for the particular per-scenario composite class based at least in part on a largest per-input individual cost measure for the per-composite-class input subset that is associated with the particular per-scenario composite class; and (ii) determining the per-composite-class cost measure for the particular per-scenario composite class based at least in part on the per-composite-class composite cost measure.

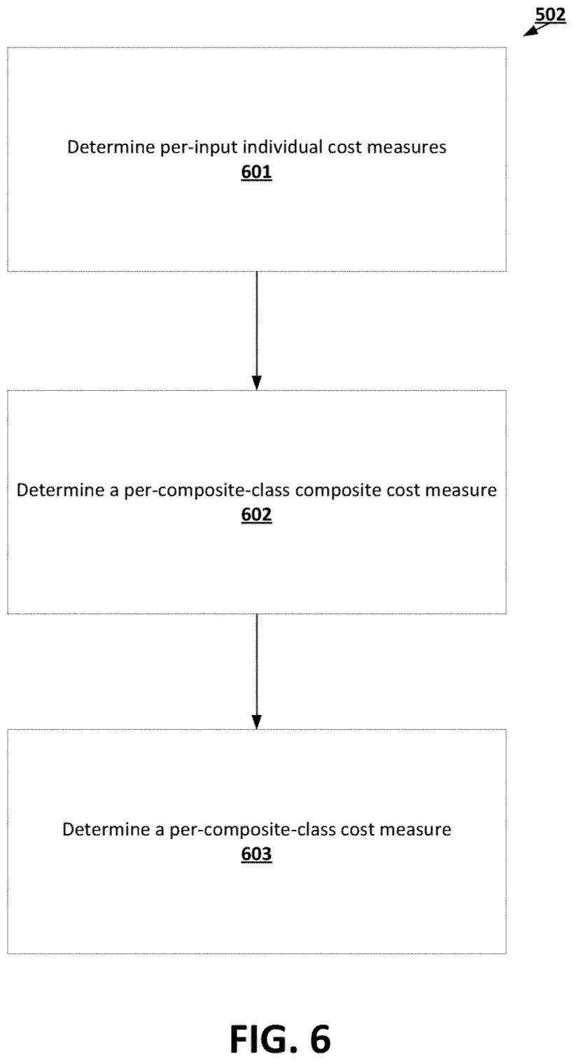

In some embodiments, step/operation 502 may be performed in accordance with the process that is depicted in FIG. 6, which is a flowchart diagram of an example process for determining a per-composite-class cost measure for a particular per-scenario composite class. The process that is depicted in FIG. 6 begins at step/operation 601 when the predictive data analysis computing entity 106 determines a per-input individual cost measure for each classification input in the per-composite-class input subset for the particular per-scenario composite class.

As described above, each composite class includes a subset of classification inputs (e.g., a subset of employees) that are hereby referred to as the per-composite-class input subset of the classification inputs for the particular composite class. For example, a composite class that is associated with salaried employees that are married and have children is associated with a per-composite-class input subset that includes salaried employees that are married with children. In some embodiments, each of the classification inputs that are in the per-composite-class input subset for a composite class is associated with a per-input individual cost measure that describes a measure of cost/utility associated with the classification input. In some of the noted embodiments, the per-input individual cost measures for classification inputs that are in the per-composite-class input subset for a particular composite class can be combined/aggregated (e.g., summed up, averaged, and/or the like) to generate the per-composite-class composite cost measure for the particular composite class.

For example, in some embodiments, the per-input individual cost measure for a particular classification input that is associated with a particular employee may describe an estimated/computed measure of employer contribution for a target cost category (e.g., a target health insurance plan type, such as a cheapest health insurance plan type) for the per-input individual cost measure. In some of the noted embodiments, the per-input individual cost measure for a particular classification input that is associated with a particular employee may describe an age-adjusted estimated/computed measure of employer contribution for a target cost category (e.g., a target health insurance plan type, such as a cheapest health insurance plan type) for the per-input individual cost measure, where the age-adjusted estimated/computed measure of employer contribution is determined by assuming that the employer has a baseline age (e.g., a baseline age of twenty years old).

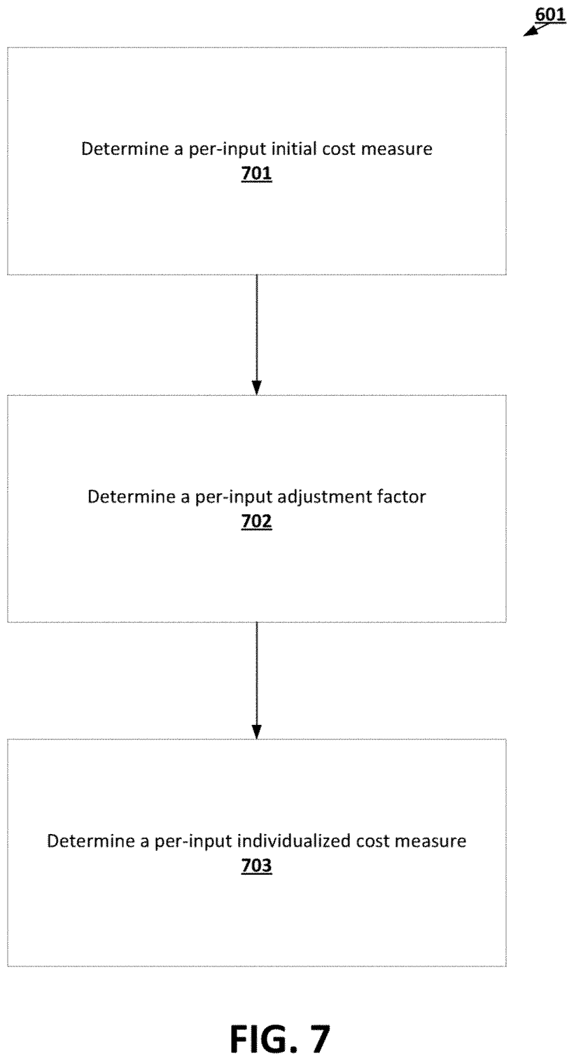

In some embodiments, step/operation 601 may be performed in accordance with the process that is depicted in FIG. 7, which is an example process for determining the per-input individual cost measure for a particular classification input. The process that is depicted in FIG. 7 begins at step/operation 701 when the predictive data analysis computing entity 106 determines a per-input initial cost measure for the particular classification input. The per-input initial cost measure may be a cost/utility measure for a classification input that is determined before any adjustments made in accordance with an adjustment feature. An example of a per-input initial cost measure may be a measure of employer contribution for a corresponding employee for a target health insurance plan that is determined based at least in part on a total cost of the target health insurance plan for the employee and a defined employer share of the total cost, without adjusting for employee.

In some embodiments, the per-input initial cost measure for a particular classification input is determined using a cost determination machine learning model associated with a target cost category. The cost determination machine learning model may be configured to process input feature data (e.g., demographic data, health history data, and/or the like) for a classification input to generate a predictive output (e.g., a total cost/utility measure) for the classification input with respect to a target cost category, where the predictive output can be used (e.g., in combination with a cost distribution ratio such as an employer contribution ratio) to generate the per-input initial cost measure for the particular classification input. In some embodiments, the cost determination machine learning model comprises one or more neural network layers, such as one or more fully-connected neural network layers. In some embodiments, input feature data processed by the cost determination machine learning model with respect to a classification input include an adjustment feature value (e.g., an age value) for the classification input, as further described below. Accordingly, in some embodiments, the predictive output generated by the cost determination machine learning model is a cost/utility measure for a classification input that is determined without discounting/adjusting for the features associated with an adjustment feature such as age. In some embodiments, inputs to the cost determination machine learning model comprise a vector describing input feature data for a classification input, while outputs of the cost determination machine learning model include a vector and/or an atomic value describing the predictive output corresponding to the classification input. In some embodiments, the cost determination machine learning model can be trained using training data describing historical costs associated with particular plans/service items for particular classification inputs.

At step/operation 702, the predictive data analysis computing entity 106 determines a per-input adjustment factor for the particular classification input. The per-input adjustment factor may describe a measure of contribution of an adjustment feature value for a particular classification input to the per-input initial cost measure for the particular classification input. For example, the per-input adjustment factor for a particular classification input may describe a ratio of: (i) the per-input initial cost measure for the particular classification input, and (ii) a baseline per-input initial cost measure for a classification input that is associated with all of the input feature data for the particular classification input except for a baseline adjustment feature value (e.g., a baseline age value, such as a baseline age value of 20 years old). In some embodiments, to generate the per-input adjustment factor for a particular classification input, the following operations are performed: (i) processing input feature data associated with the particular classification input using the cost determination machine learning model to generate a predictive output that can then be used to generate a per-input initial cost measure for the particular classification input, (ii) determining a baseline classification input that is associated with all of the input feature data of the particular classification input except that the adjustment feature value of the classification input is replaced by a baseline adjustment feature value, (iii) processing input feature data associated with the baseline classification input using the cost determination machine learning model to generate a predictive output that can then be used to generate a baseline per-input initial cost measure for the baseline classification input, and (iv) determining the per-input adjustment factor based at least in part on a ratio of the per-input initial cost measure and the baseline per-input initial cost measure.

For example, consider an employee that is 40 years old and is associated with an employer contribution measure of $1200 for a target health insurance plan. If using a cost determination machine learning model, a proposed system determines that the same employee would have had incurred an employer contribution measure of $1000 if the employee had a baseline age of 20 years old, then the adjustment factor for the employee may be determined based at least in part on the output of $1,200/$1,000=1.2.

In some embodiments, an adjustment feature value is a feature value of a classification input that can be used to determine the per-input adjustment factor for the classification input. In some embodiments, the per-input adjustment factor for a particular classification input is determined based at least in part on an adjustment feature (e.g., an age feature) having an adjustment feature range (e.g., an age value range of 20 to 80 years old, an age value range of 20 years and higher, and/or the like), each classification input is associated with an adjustment feature value (e.g., an age value) for the adjustment factor, and the adjustment factor for classification inputs having a smallest adjustment feature value (e.g., a baseline age value, such as a baseline age value of 20 years old) in the adjustment feature range are associated with an initial adjustment factor. Thus, in some embodiments, the baseline adjustment feature value for an adjustment feature is the smallest adjustment feature value for an adjustment feature range of the adjustment feature value.

At step/operation 703, the predictive data analysis computing entity 106 determines the per-input individual cost measure for the particular classification input based at least in part on the per-input initial cost measure and the per-input adjustment factor. In some embodiments, the predictive data analysis divides the per-input initial cost measure for the particular classification input by the per-input adjustment factor for the classification input to generate the per-input individual cost measure for the particular classification input. For example, given a per-input initial cost measure of $1,200 and a per-input adjustment factor of 1.2, a per-input individual cost measure of $1,200/1.2=$1,000 may be determined, which may be an individual cost measure determined by adjusting/discounting the effect of the adjustment feature value of the corresponding classification input using a baselining technique. In some embodiments, the predictive data analysis computing entity 106 processes the per-input initial cost measure for the particular classification input and the per-input adjustment factor for the classification input using one or more neural network layers (e.g., using one or more fully-connected neural network layers) to generate the per-input individual cost measure for the particular classification input.

Returning to FIG. 6, at step/operation 602, the predictive data analysis computing entity 106 determines a per-composite-class composite cost measure for the particular per-scenario composite class based at least in part on a largest per-input individual cost measure for the per-composite-class input subset that is associated with the particular per-scenario composite class. In some embodiments, the predictive data analysis computing entity 106 adopts the largest per-input individual cost measure for the per-composite-class input subset that is associated with the particular per-scenario composite class as the per-composite-class composite cost measure for the particular per-scenario composite class.

In some embodiments, given a composite class including x classification inputs which are associated with x corresponding per-input individual cost measures, the largest of the x corresponding per-input individual cost measures is adopted as the per-composite-class composite cost measure for the particular composite class. For example, given a set of x employees in a particular composite class that are associated with x corresponding age-adjusted employer contribution measures, the largest age-adjusted employer contribution measure of the x corresponding age-adjusted employer contribution measures is adopted as the per-composite-class composite cost measure for the composite class.

In some embodiments, given a composite class including x classification inputs which are associated with x corresponding per-input individual cost measures, an average measure of the largesty per-input individual cost measures of the x corresponding per-input individual cost measures is adopted as the per-composite-class composite cost measure for the particular composite class. For example, given a set of x employees in a particular composite class that are associated with x corresponding age-adjusted employer contribution measures, an average measure of the largesty age-adjusted employer contribution measures of the x corresponding age-adjusted employer contribution measures is adopted as the per-composite-class composite cost measure for the composite class.

At step/operation 603, the predictive data analysis computing entity 106 determines the per-composite-class cost measure for the particular per-scenario composite class based at least in part on the per-composite-class composite cost measure for the particular per-scenario composite class. In some embodiments, given a particular per-scenario composite class that is associated with a particular per-composite-class composite cost measure, the per-composite-class cost measure for the particular per-scenario composite class can be determined using the following operations: (i) for each classification input in the particular per-scenario composite class, determining a per-input scaled cost measure based at least in part on (e.g., by multiplying) the per-input adjustment factor for the classification input by particular per-composite-class composite cost measure for the particular per-scenario composite class, and (ii) determining the per-composite-class cost measure for the particular per-scenario composite class by aggregating/combining (e.g., summing up, averaging, and/or the like) the per-input scaled cost measures for the classification inputs in the particular per-scenario composite class.

For example, given a composite class of three employees associated with non-age-adjusted employer contribution measures of $1,800, $2,100, and $2,800, if the three employees are associated with adjustment factors of 1.5, 2.0, and 2.8, the following age-adjusted employer contribution measures may be generated: $1,200, $1,050, and $1,400. In this example, the per-composite-class composite cost measure of the composite class may be $1,400, which is the largest age-adjusted employer contribution measure for an employee in the composite class. Moreover, given the per-composite-class composite cost measure of $1,400 and the adjustment factors of 1.5, 2.0, and 2.8, the following per-input scaled cost measures may be generated for the three employees: $1,400*1.5=$2,100 for the first employee, $1,400*2.0=$2,800 for the second employee, and $1,400*2.8=$3,920 for the third employee. The per-composite-class cost measure can then be generated by summing the three per-input scaled cost measures in the following manner: $2,100+$2,800+$3,920=$8,820.

Returning to FIG. 5, at step/operation 503, the predictive data analysis computing entity 106 determines the composite classification scenario score for the particular composite classification scenario based at least in part on each per-composite-class cost measure for the per-scenario composite classes associated with the particular composite classification scenario. In some embodiments, to generate the composite classification scenario, the predictive data analysis computing entity 106 may combine/aggregate (e.g., sum up, average, and/or the like) all per-composite-class cost measures for all composite classes associated with a composite classification scenario (aka. all per-composite-class cost measures for all per-scenario composite classes associated with the composite classification scenario) to generate an aggregation layer output that can then be used to generate the composite classification scenario score for the composite classification scenario. In some embodiments, combining all per-composite-class cost measures for all per-scenario composite classes associated with the composite classification scenario comprises processing all per-composite-class cost measures for all per-scenario composite classes associated with the composite classification scenario using the composite classification scenario machine learning model to generate the aggregation layer output. In some embodiments, inputs to the composite classification scenario machine learning model include a vector describing all per-composite-class cost measures for all per-scenario composite classes associated with the composite classification scenario, while outputs of the composite classification scenario machine learning model include a vector or an atomic value describing the composite classification scenario score for the composite classification scenario.

For example, given a composite classification scenario associated with a family tier classification feature and a salaried status classification feature that is associated with four composite classes, where the four composite classes are in turn associated with per-composite-class cost measures of $8,000, $3,000, $5,000, and $1,500, the four per-composite-class cost measures may be summed to generate a composite classification score of $8,000+$3,000+$5,000+$1,500=$17,500 for the composite classification scenario.

Returning to FIG. 4, at step/operation 404, the predictive data analysis computing entity 106 determines m (e.g., three) composite classification scenarios from the plurality of composite classification scenarios based at least in part on each composite classification scenario for the set of composite classification scenarios determined at step/operation 403. In some embodiments, at step/operation 404, the predictive data analysis computing entity 106 selects the m composite classification scenarios having the top m composite classification scenario scores among the set of composite classification scenarios determined at step/operation 403.

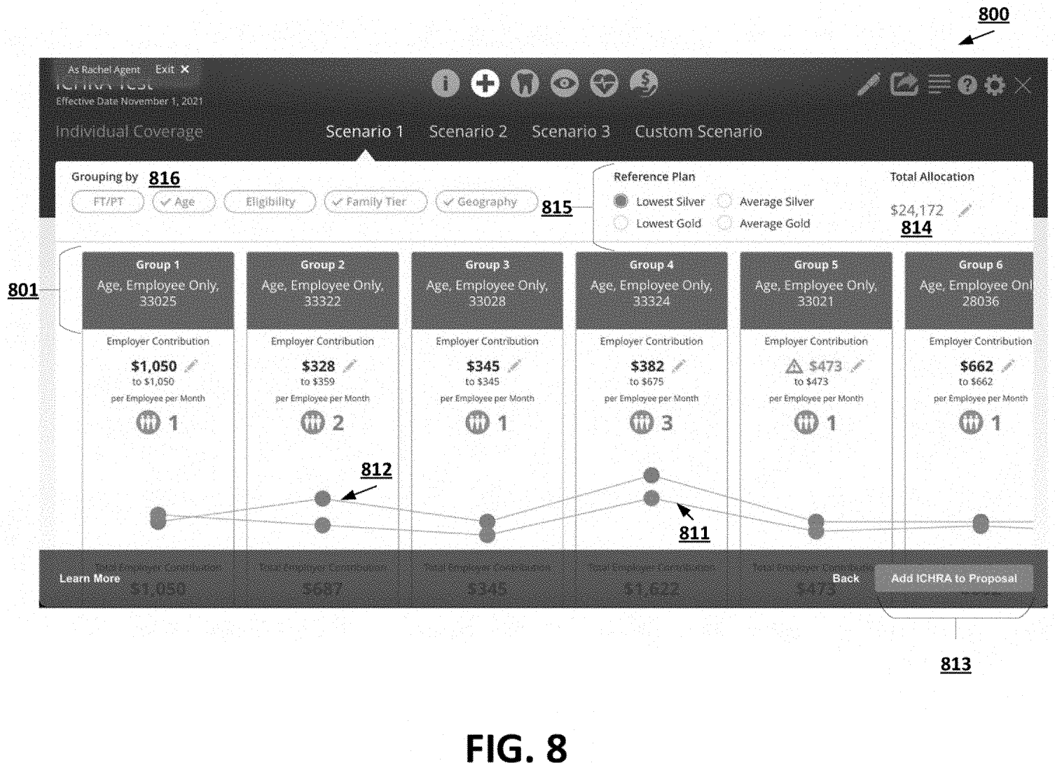

At step/operation 405, the predictive data analysis computing entity 106 performs one or more classification-based actions based at least in part on the m composite classification scenarios. In some embodiments, the predictive data analysis computing entity 106 generates user interface data for a prediction output user interface that displays predictive inference metadata for the m composite classification scenarios, where the user interface data may be used to display the prediction output user interface (e.g., using a client computing entity). An operational example of such a prediction output user interface 800 is depicted in FIG. 8. As depicted in FIG. 8, the prediction output user interface 800 displays prediction metadata for top three composite classification scenarios.

As further depicted in FIG. 8, with respect to each selected composite classification scenario, the prediction output user interface 800 displays metadata associated with the composite classes associated with the selected composite classification scenario, such as the composite classes 801 associated with the top composite classification scenario (e.g., a first composite class that is associated with employees with no children that live in the geographical region associated with the zip code 33025 that is adjusted based at least in part on age). For each displayed composite class, the prediction output user interface 800 displays: (i) the adjustment feature for the composite class (e.g., the adjustment feature of age for the first composite class), (ii) the classification feature values associated with the composite class (e.g., the family tier classification feature value of “Employees Only” and the geographical classification feature value of 33025 for the first composite class), (iii) a range whose lower bound is the lowest per-input individualized cost measure for classification inputs associated with the composite class and whose upper bound is the highest lowest per-input individualized cost measure for classification inputs associated with the composite class (e.g., the range [$1,050, $1,050] for the first composite class), (iv) the count of classification inputs (e.g., employees) that are associated with the composite class (e.g., the count of one for the first composite class), and (v) the per-composite-class cost measure for the composite class (e.g., the per-composite-class cost measure of $1,050 for the first composite class).

As further depicted in FIG. 8, the prediction output user interface 800 further displays: (i) a graph user interface element 811 that displays relative fluctuations of per-composite-class cost measures across the displayed composite classes of the selected composite classification scenario, (ii) a graph user interface element 812 that displays relative fluctuations of associated classification input counts across the displayed composite classes of the selected composite classification scenario, (iii) a user interface element 813 that enables adopting the selected composite classification scenario as part of an ICHRA proposal, (iv) a user interface element 814 that displays composite classification scenario score associated with the composite classification scenario, (v) a user interface element 815 that enables selecting the target cost category associated with the composite classification scenario analysis performed using the prediction output user interface 800, and (vi) a user interface element 816 that displays the adjustment factor (i.e., age) and the classification features (e.g., family tier and geography) associated with the selected composite classification scenario.

Examples of classification-based actions that can be performed using the various embodiments of the present invention include: (i) generating user interface data for a prediction output user interface, (ii) displaying a prediction output user interface, (iii) automatically scheduling one or more service registration operations (e.g., health insurance plan registration operations) based at least in part on the selected m composite classification scenarios, (iv) automatically adjusting operational load balancing operations for servers of a service delivery institution (e.g., health insurance company servers) based at least in part on expected volume of service registrations (e.g., ICHRA plan registrations) as determined based at least in part on contents of service plan proposals (e.g., ICHRA proposals), (v) automatically performing one or more service delivery tasks, (vi) automatically scheduling one or more service delivery tasks, (vii) automatically scheduling one or more subject matter expert review tasks, and/or the like.

As discussed above, to address the challenges associated with performing composite classification of a set of classification inputs in a computationally efficient manner, various embodiments of the present invention distribute the largest per-input individual cost measure for a composite class defined under a composite classification scenario to all of the classification inputs associated with the composite class. The result is a massive simplification of the composite classification scenario optimization process from a computational standpoint, with some embodiments reducing the computational complexity of the overall process to a linear computational complexity that depends on the number of potential composite classification scenarios. Through using the noted techniques, various embodiments of the present invention address technical challenges related to performing composite classification of a set of classification inputs in a computationally efficient manner and make important technical contributions to the field of unsupervised machine learning model.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for composite classification of a plurality of classification inputs, the computer-implemented method comprising:
identifying, using one or more processors, a plurality of classification features, wherein each classification feature is associated with a plurality of classification feature values;
identifying, using the one or more processors, a plurality of initial classes, wherein each initial class comprises a per-initial-class input subset of the plurality of classification inputs that are associated with a respective classification feature value for a respective classification feature;
determining, using the one or more processors, a plurality of composite classification scenarios, wherein:
each composite classification scenario is associated with an n-sized classification feature combination that is selected from the plurality of classification features,
each composite classification scenario is associated with n per-scenario initial class subsets of the plurality of initial classes each associated with a corresponding classification feature in the n-sized classification feature combination, and
each composite classification scenario is associated with a plurality of per-scenario composite classes each associated with an n-sized per-composite-class initial class subset of the plurality of initial classes comprising n initial classes each being selected from a distinct per-scenario subset for the composite classification scenario;
for each composite classification scenario, determining, using the one or more processors and a composite classification scenario scoring machine learning model, and based at least in part on each per-scenario composite class for the composite classification scenario, a composite classification scenario score for the composite classification scenario;
determining, using the one or more processors, m composite classification scenarios from the plurality of composite classification scenarios based at least in part on each composite classification scenario; and
performing, using the one or more processors, one or more classification-based actions based at least in part on the m composite classification scenarios.

2. The computer-implemented method of claim 1, wherein determining the composite classification scenario score for a particular composite classification scenario using the composite classification scenario scoring machine learning model comprises:
for each per-scenario composite class associated with the particular composite classification scenario, determining a per-composite-class cost measure based at least in part on each per-input cost measure for a per-composite-class input subset of the plurality of classification inputs that are associated with the n-sized per-composite-class initial class subset for the per-scenario composite class; and
determining, based at least in part on each per-composite-class cost measure, the composite classification scenario score for the particular composite classification scenario.

3. The computer-implemented method of claim 2, wherein determining the per-composite-class cost measure for a particular per-scenario composite class that is associated with the particular composite classification scenario comprises:
for each classification input in the per-composite-class input subset that is associated with the particular per-scenario composite class, determining a per-input individual cost measure,
determining a per-composite-class composite cost measure for the particular per-scenario composite class based at least in part on a largest per-input individual cost measure for the per-composite-class input subset that is associated with the particular per-scenario composite class; and
determining the per-composite-class cost measure for the particular per-scenario composite class based at least in part on the per-composite-class composite cost measure.

4. The computer-implemented method of claim 3, wherein determining the per-input individual cost measure for a particular classification input in the per-composite-class input subset that is associated with the particular per-scenario composite class comprises:
determining a per-input initial cost measure for the particular classification input;
determining a per-input adjustment factor for the particular classification input; and
determining the per-input individual cost measure for the particular classification input based at least in part on the per-input initial cost measure and the per-input adjustment factor.

5. The computer-implemented method of claim 4, wherein determining the per-composite-class cost measure for the particular per-scenario composite class based at least in part on the per-composite-class composite cost measure comprises:
for each classification input in the per-composite-class input subset that is associated with the particular per-scenario composite class, determining a per-input composite cost measure based at least in part on the per-input adjustment factor for the classification input and the per-composite-class composite cost measure for the particular per-scenario composite class; and
determining the per-composite-class cost measure based at least in part on each per-input composite cost measure.

6. The computer-implemented method of claim 5, wherein:
the per-input adjustment factor is determined based at least in part on an adjustment feature having an adjustment feature range,
each classification input is associated with an adjustment feature value for the adjustment feature, and
the per-input adjustment factor for classification inputs having a smallest adjustment feature value in the adjustment feature range are associated with an initial adjustment factor.

7. The computer-implemented method of claim 4, wherein determining the per-input initial cost measure for the particular classification input comprises:
determining, based at least in part on input feature data associated with the classification input and using a cost determination machine learning model associated with a target cost category, the per-input initial cost measure.

8. An apparatus for composite classification of a plurality of classification inputs, the apparatus comprising at least one processor and at least one memory including program code, the at least one memory and the program code configured to, with the processor, cause the apparatus to at least:
identify a plurality of classification features, wherein each classification feature is associated with a plurality of classification feature values;
identify a plurality of initial classes, wherein each initial class comprises a per-initial-class input subset of the plurality of classification inputs that are associated with a respective classification feature value for a respective classification feature;
determine a plurality of composite classification scenarios, wherein:
each composite classification scenario is associated with an n-sized classification feature combination that is selected from the plurality of classification features,
each composite classification scenario is associated with n per-scenario initial class subsets of the plurality of initial classes each associated with a corresponding classification feature in the n-sized classification feature combination, and
each composite classification scenario is associated with a plurality of per-scenario composite classes each associated with an n-sized per-composite-class initial class subset of the plurality of initial classes comprising n initial classes each being selected from a distinct per-scenario subset for the composite classification scenario;
for each composite classification scenario, determine, using a composite classification scenario scoring machine learning model, and based at least in part on each per-scenario composite class for the composite classification scenario, a composite classification scenario score for the composite classification scenario;
determine m composite classification scenarios from the plurality of composite classification scenarios based at least in part on each composite classification scenario; and
perform one or more classification-based actions based at least in part on the m composite classification scenarios.

9. The apparatus of claim 8, wherein determining the composite classification scenario score for a particular composite classification scenario using the composite classification scenario scoring machine learning model comprises:
for each per-scenario composite class associated with the particular composite classification scenario, determining a per-composite-class cost measure based at least in part on each per-input cost measure for a per-composite-class input subset of the plurality of classification inputs that are associated with the n-sized per-composite-class initial class subset for the per-scenario composite class; and
determining, based at least in part on each per-composite-class cost measure, the composite classification scenario score for the particular composite classification scenario.

10. The apparatus of claim 9, wherein determining the per-composite-class cost measure for a particular per-scenario composite class that is associated with the particular composite classification scenario comprises:
for each classification input in the per-composite-class input subset that is associated with the particular per-scenario composite class, determining a per-input individual cost measure,
determining a per-composite-class composite cost measure for the particular per-scenario composite class based at least in part on a largest per-input individual cost measure for the per-composite-class input subset that is associated with the particular per-scenario composite class; and
determining the per-composite-class cost measure for the particular per-scenario composite class based at least in part on the per-composite-class composite cost measure.

11. The apparatus of claim 10, wherein determining the per-input individual cost measure for a particular classification input in the per-composite-class input subset that is associated with the particular per-scenario composite class comprises:
determining a per-input initial cost measure for the particular classification input;
determining a per-input adjustment factor for the particular classification input; and
determining the per-input individual cost measure for the particular classification input based at least in part on the per-input initial cost measure and the per-input adjustment factor.

12. The apparatus of claim 11, wherein determining the per-composite-class cost measure for the particular per-scenario composite class based at least in part on the per-composite-class composite cost measure comprises:
for each classification input in the per-composite-class input subset that is associated with the particular per-scenario composite class, determining a per-input composite cost measure based at least in part on the per-input adjustment factor for the classification input and the per-composite-class composite cost measure for the particular per-scenario composite class; and
determining the per-composite-class cost measure based at least in part on each per-input composite cost measure.

13. The apparatus of claim 12, wherein:
the per-input adjustment factor is determined based at least in part on an adjustment feature having an adjustment feature range,
each classification input is associated with an adjustment feature value for the adjustment feature, and
the per-input adjustment factor for classification inputs having a smallest adjustment feature value in the adjustment feature range are associated with an initial adjustment factor.

14. The apparatus of claim 11, wherein determining the per-input initial cost measure for the particular classification input comprises:
determining, based at least in part on input feature data associated with the classification input and using a cost determination machine learning model associated with a target cost category, the per-input initial cost measure.

15. A computer program product for composite classification of a plurality of classification inputs, the computer program product comprising at least one non-transitory computer-readable storage medium having computer-readable program code portions stored therein, the computer-readable program code portions configured to:
identify a plurality of classification features, wherein each classification feature is associated with a plurality of classification feature values;
identify a plurality of initial classes, wherein each initial class comprises a per-initial-class input subset of the plurality of classification inputs that are associated with a respective classification feature value for a respective classification feature;
determine a plurality of composite classification scenarios, wherein:
each composite classification scenario is associated with an n-sized classification feature combination that is selected from the plurality of classification features,
each composite classification scenario is associated with n per-scenario initial class subsets of the plurality of initial classes each associated with a corresponding classification feature in the n-sized classification feature combination, and
each composite classification scenario is associated with a plurality of per-scenario composite classes each associated with an n-sized per-composite-class initial class subset of the plurality of initial classes comprising n initial classes each being selected from a distinct per-scenario subset for the composite classification scenario;
for each composite classification scenario, determine, using a composite classification scenario scoring machine learning model, and based at least in part on each per-scenario composite class for the composite classification scenario, a composite classification scenario score for the composite classification scenario;
determine m composite classification scenarios from the plurality of composite classification scenarios based at least in part on each composite classification scenario; and
perform one or more classification-based actions based at least in part on the m composite classification scenarios.

16. The computer program product of claim 15, wherein determining the composite classification scenario score for a particular composite classification scenario using the composite classification scenario scoring machine learning model comprises:
for each per-scenario composite class associated with the particular composite classification scenario, determining a per-composite-class cost measure based at least in part on each per-input cost measure for a per-composite-class input subset of the plurality of classification inputs that are associated with the n-sized per-composite-class initial class subset for the per-scenario composite class; and
determining, based at least in part on each per-composite-class cost measure, the composite classification scenario score for the particular composite classification scenario.

17. The computer program product of claim 16, wherein determining the per-composite-class cost measure for a particular per-scenario composite class that is associated with the particular composite classification scenario comprises:
for each classification input in the per-composite-class input subset that is associated with the particular per-scenario composite class, determining a per-input individual cost measure,
determining a per-composite-class composite cost measure for the particular per-scenario composite class based at least in part on a largest per-input individual cost measure for the per-composite-class input subset that is associated with the particular per-scenario composite class; and
determining the per-composite-class cost measure for the particular per-scenario composite class based at least in part on the per-composite-class composite cost measure.

18. The computer program product of claim 17, wherein determining the per-input individual cost measure for a particular classification input in the per-composite-class input subset that is associated with the particular per-scenario composite class comprises:
determining a per-input initial cost measure for the particular classification input;
determining a per-input adjustment factor for the particular classification input; and
determining the per-input individual cost measure for the particular classification input based at least in part on the per-input initial cost measure and the per-input adjustment factor.

19. The computer program product of claim 18, wherein determining the per-composite-class cost measure for the particular per-scenario composite class based at least in part on the per-composite-class composite cost measure comprises:
for each classification input in the per-composite-class input subset that is associated with the particular per-scenario composite class, determining a per-input composite cost measure based at least in part on the per-input adjustment factor for the classification input and the per-composite-class composite cost measure for the particular per-scenario composite class; and
determining the per-composite-class cost measure based at least in part on each per-input composite cost measure.

20. The computer program product of claim 19, wherein:
the per-input adjustment factor is determined based at least in part on an adjustment feature having an adjustment feature range,
each classification input is associated with an adjustment feature value for the adjustment feature, and
the per-input adjustment factor for classification inputs having a smallest adjustment feature value in the adjustment feature range are associated with an initial adjustment factor.
